(19) United States
(12) Patent Application Publication
(10) Pub. No.: US 2010/0142111 A1
(43) Pub. Date: Jun. 10, 2010

(54) Electronic Device

(75) Inventor: Kazunori KOTANI, Nara-shi (JP)

Correspondence Address: NOVAK DRUCE + QUIGG LLP, 1300 EYE STREET NW, SUITE 1000 WEST TOWER, WASHINGTON, DC, 20005, US

(73) Assignee: SANYO ELECTRIC CO., LTD., Osaka (JP)

(21) Appl. No.: 12/630,434

(22) Filed: Dec. 3, 2009

(30) Foreign Application Priority Data
Dec. 5, 2008 (JP) 2008311366

(51) Int. Cl. H05F 3/00

(52) U.S. Cl. 361/220

(57) ABSTRACT

An electronic device including a printed wiring board, which is accommodated in a housing. The printed wiring board includes a substrate, a ground layer on the substrate, a discharge conductive portion exposed from an outmost surface of the printed wiring board to provide an antistatic structure, and a plurality of vias extending through the substrate. The discharge conductive portion and the ground layer are electrically connected to each other by at least two of the vias.

### CROSS-REFERENCE TO RELATED APPLICATIONS

This application is based upon and claims the benefit of priority from prior Japanese Patent Application No. 2008-311366, filed on Dec. 5, 2008, the entire contents of which are incorporated herein by reference.

### BACKGROUND OF THE INVENTION

The present invention relates to an electronic device, and more particularly, to an electric device including an antistatic printed wiring board.

When a person operates a push button of an electronic device and static charge is built up in that person's body, static electricity may be discharged toward a printed wiring board that is accommodated in a housing of the electronic device. Such electrostatic discharge may be undesirable for the electronic device. Japanese Laid-Open Patent Publication No. 2007-207497 describes an antistatic structure formed on a substrate, which is used as a printed wiring board.

The electronic device of the '497 publication includes a housing and a printed wiring board, which is accommodated in the housing. The printed wiring board includes, for example, a substrate, a ground layer (GND) applied to the substrate, an antistatic discharge conductive portion (discharge GND land) exposed from the outmost surface of the printed wiring board, and a via (via hole) formed in the substrate.

### SUMMARY OF THE INVENTION

However, even when using the printed wiring board provided with the antistatic structure of the '497 publication, the impedance between the discharge conductive portion and the ground layer, which provides a reference potential for the printed wiring board, may not be sufficiently decreased. Accordingly, the antistatic structure of the '497 publication possess lower reliability.

The present invention provides an electronic device that implements antistatic structure having improved reliability.

One aspect of the present invention is an electronic device including a housing and a printed wiring board accommodated in the housing. The printed wiring board includes a substrate, a ground layer disposed on the substrate, a discharge conductive portion exposed from an outmost surface of the printed wiring board to provide an antistatic structure, and a plurality of vias arranged in the substrate. The discharge conductive portion and the ground layer are electrically connected to each other by at least two of the vias.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a perspective view showing an electronic device according to one embodiment of the present invention;

FIG. 2 is a cross-sectional view of the electronic device shown in FIG. 1;

FIG. 3 is partial plan view showing a printed wiring board of the electronic device shown in FIG. 1;

FIG. 4 is partial bottom view showing the printed wiring board of the electronic device shown in FIG. 1;

FIG. 5 is a cross-sectional diagram of the printed wiring board taken along line A-A in FIG. 3;

FIG. 6 is a cross-sectional diagram of the printed wiring board taken along line B-B in FIG. 3;

FIG. 7 is a partial plan view showing a modified printed wiring board; and

FIG. 8 is a partial bottom view showing the modified printed wiring board.

### DETAILED DESCRIPTION OF EMBODIMENTS

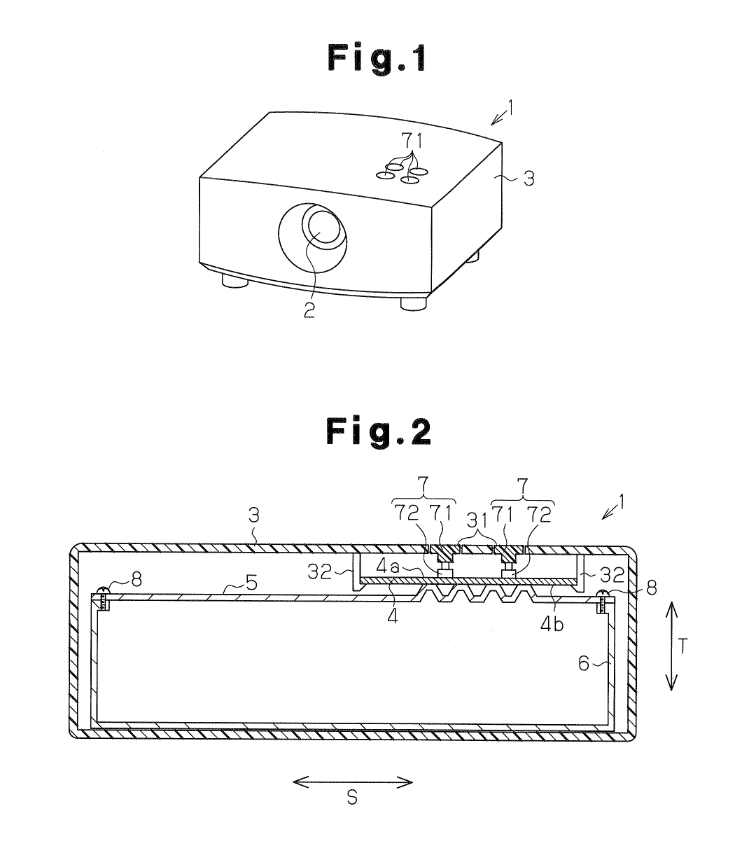

An electronic device according to one embodiment of the present invention will now be discussed. FIG. 1 shows a video projector 1, which is one example of an electronic device. In FIG. 2, arrow S indicates a planar direction S, which is parallel to a component mounting surface (upper surface 4a) of a printed wiring board 4. Further, arrow T indicates a vertical direction (widthwise direction), which is orthogonal to the component mounting surface.

Referring to FIG. 1, the video projector 1 is a front projector that projects light toward the front via a projection lens 2 to display a picture.

As shown in FIG. 2, the video projector 1 includes a housing 3. The housing 3 accommodates optical components, such as LCD panels for transmitting light and generating a picture, the printed wiring board 4, a grounded conductor plate 5, and a conductor 6, which provides reference potential for the video projector 1.

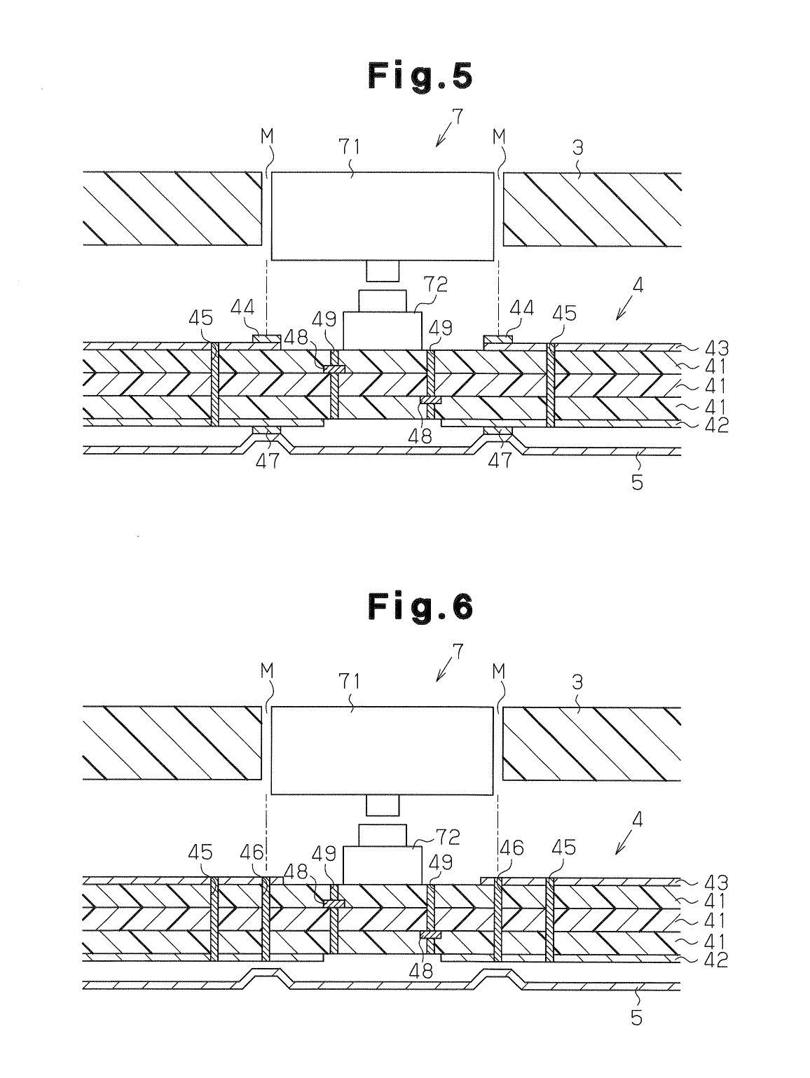

The video projector 1 includes push buttons 71, which are operated by a user. The push buttons 71 are arranged in through holes (button holes) 31, which are formed in the outer surface of the housing 3. Each push button 71 includes a top surface exposed outside the video projector. Each push button 71 is configured to push a corresponding switch 72, which is an electronic component arranged on the printed wiring board 4. Each push button and the corresponding switch 72 form a push button switch 7. In the planar direction S of the printed wiring board 4, the push button 71 may be larger than the switch 72. In the illustrated example, an annular slit aperture M is formed between the housing 3 (the surface defining the through hole 31) and the push button 71 (refer to FIG. 5).

The printed wiring board 4 is supported by wiring board supports 32 arranged in the housing 3. The wiring board supports 32 each extend into the housing 3. In the illustrated example, the wiring board supports 32 and the housing 3 are molded integrally from a resin.

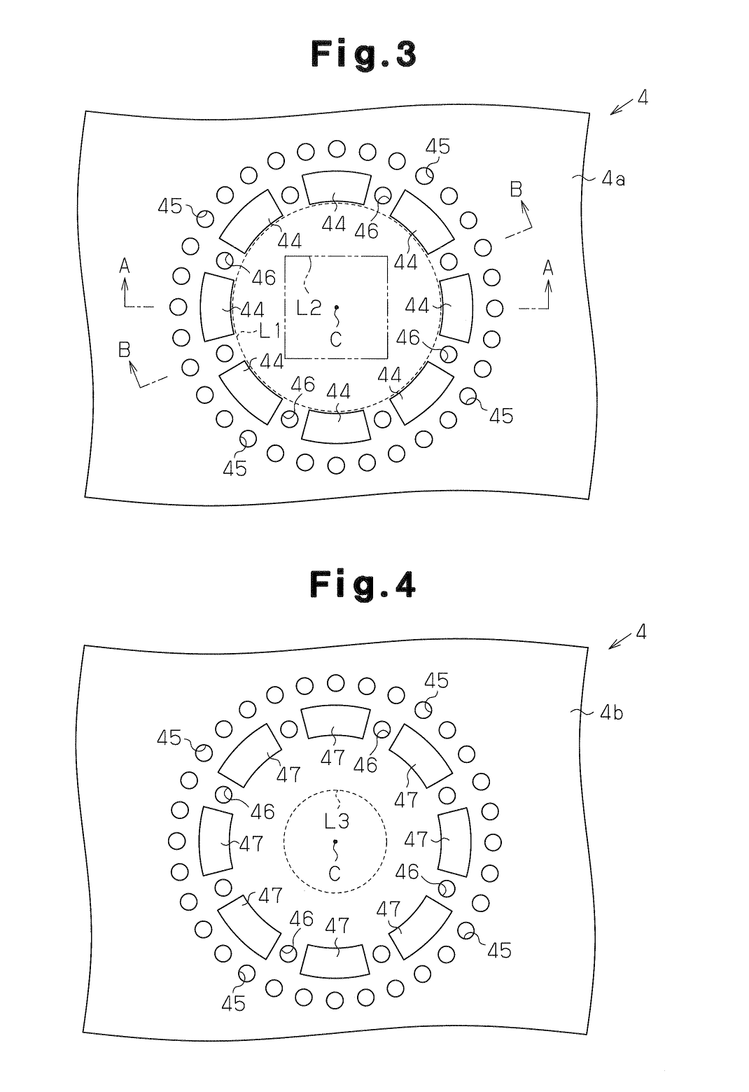

FIGS. 3 and 4 are respectively a plan view and bottom view showing the printed wiring board 4. The printed wiring board 4 has an upper surface 4a and a lower surface 4b, which are also respectively referred to as a first outmost surface and a second outmost surface. The printed wiring board 4 includes a control circuit, which controls the video projector 1. Further, the printed wiring board 4 includes an antistatic pattern, which is shown in FIGS. 3 and 4.

As shown in FIG. 5, the printed wiring board 4 includes one or more substrates 41, ground layers 42 and 43, one or more discharge conductive portions 44 exposed from the outmost surface to provide an antistatic structure, and a plurality of vias 45 extending through the substrates 41. The ground layer 42 may be disposed on the bottom of the undermost one of the substrates 41. The ground layer 43 may be disposed on the top of the uppermost one of the substrates 41. The ground layers 42 and 43 may be partially coated with a non-conductive or insulative coating layer (so-called solder mask, not shown).

The substrates 41 may be insulating layers formed from a dielectric or insulative resin. When the printed wiring board 4 is a multilayer printed wiring board, a plurality of the substrates 41 are superimposed upon one another. Instead of the plurality of substrates 41 shown in FIG. 5, a single substrate 41 may be used in the printed wiring board 4. Such a printed wiring board 4 is a double-surface printed wiring board including the single substrate 41 having two opposite surfaces in which the ground layers 42 and 43 are superimposed.

The ground layers 42 and 43 are each directly or indirectly connected to the conductor 6 (refer to FIG. 2) to be grounded. The ground layers 42 and 43 are conductive layers formed from a metal sheet such as copper foil. The ground layer 42, which is disposed on the bottom of the undermost one of the substrates 41, is exposed on the lower surface 4b of the printed wiring board 4. The ground layer 43, which is disposed on the top of the uppermost one of the substrates 41, is exposed on the upper surface 4a of the printed wiring board 4. The ground layers 42 and 43 are electrically connected to the conductor plate 5, which is grounded by the conductor 6. In the present embodiment, the ground layer 42 functions as a conductor that provides a reference potential for the circuits in the printed wiring board 4.

The coating layer is insulative and thus not arranged at locations electrically connecting the ground layer 42 and the conductor plate 5 and at the discharge conductive portions 44 on the ground layer 43.

The discharge conductive portions 44, which provide an antistatic structure, are formed by conductors arranged on the ground layer 43. The discharge conductive portions 44 may be formed in the same manner as lands used to mount components. Further, the discharge conductive portions 44 may be formed, for example, by performing a reflow process and applying a solder paste with a metal mask.

The discharge conductive portions 44, which are arranged on the upper surface 4a of the printed wiring board 4, are electrically connected by the vias 45 to the ground layer 42 exposed on the lower surface 4b of the printed wiring board 4. Further, the discharge conductive portions 44 are each spaced by a predetermined distance (e.g., 1 mm or more) in the planar direction S from the arrangement location of the corresponding switch 72. Thus, the discharge conductive portions 44 are arranged so as to surround the corresponding switch 72. In the example of FIG. 3, the discharge conductive portions 44 are circularly-disposed on the printed wiring board 4 along a hypothetical circle, the center of which coincides with the center C of the corresponding switch 72. The discharge conductive portions 44 are spaced apart from one another. Here, the discharge conductive portions 44 are located immediately below the slit aperture M and are arranged in alignment with the slit aperture M (refer to FIG. 5) and faces toward the slit aperture M. Each discharge conductive portion 44 may be substantially rectangular when viewed in the thicknesswise direction T.

Each via 45 is a plated through hole. The vias 45 connect the ground layer 42 and ground layer 43. Accordingly, the discharge conductive portions 44 are connected by the ground layer 43 and the vias 45 to the ground layer 42. The vias 45 are arranged so as to surround the corresponding switch 72. In the illustrated example, the vias 45 are circularly-disposed on the printed wiring board 4 along a hypothetical circle, the center of which coincides with the center C of the corresponding switch 72. The vias 45 are arranged in concentricity with the discharge conductive portions 44. The hypothetical circle along which the vias 45 are arranged is formed radially outward from the hypothetical circle along which the discharge conductive portions 44 are arranged. Thus, the hypothetical circle of the vias 45 has a similarity shape of the slit aperture M.

The conductor plate 5 is a metal plate of, for example, steel or aluminum. The conductor plate 5 is fastened by screws 8 to the conductor 6, which provides the reference potential for the video projector 1. Accordingly, the conductor 6, the conductor plate 5, the ground layer 42, and the discharge conductive portions 44 are electrically connected to one another. The connection of the ground layer 42 and the conductor 6 increases the capacitance and decreases potential variations at the discharge conductive portions 44 connected to the ground layer 42.

As described above, the video projector 1 includes the housing 3 and the printed wiring board 4, which is accommodated in the housing 3. The printed wiring board 4 includes the substrates 41, the ground layer 42 disposed on the uppermost one of the substrates 41, the discharge conductive portions 44 exposed from the outmost surface of the printed wiring board 4, and the vias 45 extending through the substrates 41. The discharge conductive portions 44 are each electrically connected to the ground layer 42 by at least two of the vias 45.

The ground layer 43 is in electrical connection with each one of the vias surrounding the switch 72. Further, referring to FIG. 3, in the same manner as the discharge conductive portions 44, the ground layer 43 is spaced by a predetermined distance in the planar direction S from each corresponding switch 72. More specifically, the ground layer 43 is arranged outside the dotted line L1 and spaced by the predetermined distance from the center C of each switch 72 on the printed wiring board 4. Each discharge conductive portion 44 is connected by the ground layer 43, which serves as a conductive layer, to two or more vias 45. Thus, each discharge conductive portion 44 is connected to the ground layer 42 at multiple points by the two or more vias 45. Since each discharge conductive portion 44 is connected to the ground layer 42 by multiple parallel-connected vias 45, the impedance between the discharge conductive portion 44 and the ground layer 42 is the combined impedance of each via 45.

In FIG. 3, the region inside the double-dashed line L2 is where the switch 72, vias 49, and patterns may be arranged on the printed wiring board 4. The switch 72, terminals (not shown) of the switch 72, and wiring patterns (not shown) exposed from the outmost surface of the printed wiring board 4 are arranged in the region inside the double-dashed line L2. The region inside the dotted line L1 and outside the double-dashed line L2 on the surface of the printed wiring board 4 functions as a clearance region that is free from the ground layer 43, the discharge conductive portions 44, the terminals of the switch 72, and conductors such as the wiring patterns.

The ground layer 42 is also in electrical connection with each one of the vias 45 surrounding each switch 72 and spaced by a predetermined gap from the switches 72 on the printed wiring board 4. More specifically, the ground layer 42 is arranged outside the dotted line L3 shown in FIG. 4 and spaced by a predetermined distance from the center C of each switch 72. The vias 49 (refer to FIGS. 5 and 6), which electrically connect the terminals of the switch 72 to conductive layers 48 (refer to FIGS. 5 and 6), are arranged in the region inside the broken lines L3 in FIG. 4. This increases the impedance between the vias 49 and the ground layer 42 and relatively decreases the impedance between the discharge conductive portions 44 and the conductor plate through the ground layer 42.

In the present embodiment, the discharge conductive portions 44 are arranged on the printed wiring board 4 around each switch 72, and vias 46 are arranged between the discharge conductive portions 44. Like the vias 45, each via 46 is a plated through hole, and the vias 46 connect the ground layer 42 and the ground layer 43. Such a structure effectively uses the space between the discharge conductive portions 44 when the discharge conductive portions 44 cannot be arranged in conformance with the shape of the slit aperture M (i.e., when the switch 72 cannot be surrounded by a single discharge conductive portion 44) due to reasons such as the shape of a metal mask that forms the discharge conductive portion 44.

A plurality of ground connection portions 47, which are arranged on the ground layer 42, are in contact with the conductor plate 5. This electrically connects the ground layer 42 to the conductor plate 5.

Each ground connection portion 47 is a conductor and may be formed, for example, from solder paste in the same manner as the discharge conductive portions 44. The ground connection portions 47 are electrically connected to the ground layer 43 by the vias 45. Each ground connection portion 47 is spaced by a predetermined distance in the planar direction S from the center C of the corresponding switch 72. The ground connection portions 47 are arranged on the printed wiring board 4 so as to surround the corresponding switch 72.

The video projector 1 of the present embodiment has the advantages described below.

(1) The discharge conductive portions 44 are electrically connected to the ground layer 42 by at least two of the vias 45. Each discharge conductive portion 44 is grounded to the ground layer 42 at multiple points. This ensures that the impedance between the discharge conductive portions 44 and the ground layer 42 is decreased and thereby improves the reliability of the antistatic structure.

(2) The switches 72 are arranged on the printed wiring board 4, and the vias 45 are arranged on the printed wiring board 4 so as to surround each switch 72. Among the vias 45 surrounding the switch 72, the vias 45 that are closest to the switch 72 contributes to connection of the discharge conductive portions 44 and the ground layer 42. This ensures that the impedance between the discharge conductive portions 44 and the ground layer 42 is decreased and thereby improves the reliability of the antistatic structure.

(3) The printed wiring board 4 includes the further ground layer 43, on which the discharge conductive portions 44 are arranged. The discharge conductive portions 44 and the further ground layer 43 are spaced by a predetermined distance from each switch 72. This increases the impedance between the discharge conductive portions 44 and switch 72 and between the ground layer 43 and switch 72, while relatively decreasing the impedance between the discharge conductive portion 44 and ground layer 42. As a result, the reliability of the antistatic structure is further improved.

(4) The ground layer 42 is spaced by a predetermined distance from the center C of each switch 72. Such a structure increases the impedance between the vias 49 and the ground layer 42, while relatively decreasing the impedance between the discharge conductive portions 44 and the conductor plate 5 through the ground layer 42.

(5) The video projector 1 includes the push buttons 71, which push the switches 72. The discharge conductive portions 44 are aligned with and face toward the slit aperture M formed between the housing 3 and each push button 71. This facilitates the discharge of static electricity from the slit aperture M between the housing 3 and each push button 71 to the discharge conductive portions 44.

(6) The discharge conductive portions 44 are arranged to surround each switch 72. Each via 46 is sandwiched between two adjacent ones of the discharge conductive portions 44. Such a structure effectively uses the space between the discharge conductive portions 44 when the switch 72 cannot be surrounded by a single discharge conductive portion 44 due to the shape of a metal mask that forms the discharge conductive portion 44 from a solder paste. Thus, in comparison with when a via 46 is not formed between the discharge conductive portions 44, decrease in the impedance of the discharge conductive portions 44 is further ensured.

(7) The discharge conductive portions 44 each have a substantially rectangular shape when shown in plan view. Thus, in comparison with when the discharge conductive portions 44 each have a circular shape, the area of the discharge conductive portions 44 may be increased more easily in the circumferential direction extending around each switch 72 on the printed wiring board 4.

(8) The video projector 1 includes the conductor plate 5, which is grounded and accommodated in the housing 3, and the ground connection portions 47, which is arranged on the ground layer 42. The ground connection portions 47 contact the conductor plate 5 and electrically connect the ground layer 42 and the conductor plate 5. Thus, even if the coating layer is partially formed on the ground layer 42, the connection of the ground layer 42 to the conductor plate 5 is ensured. This ensures that the impedance of the discharge conductive portions 44 is further decreased. As a result, the reliability of the antistatic structure is further improved.

It should be apparent to those skilled in the art that the present invention may be embodied in many other specific forms without departing from the spirit or scope of the invention. Particularly, it should be understood that the present invention may be embodied in the following forms.

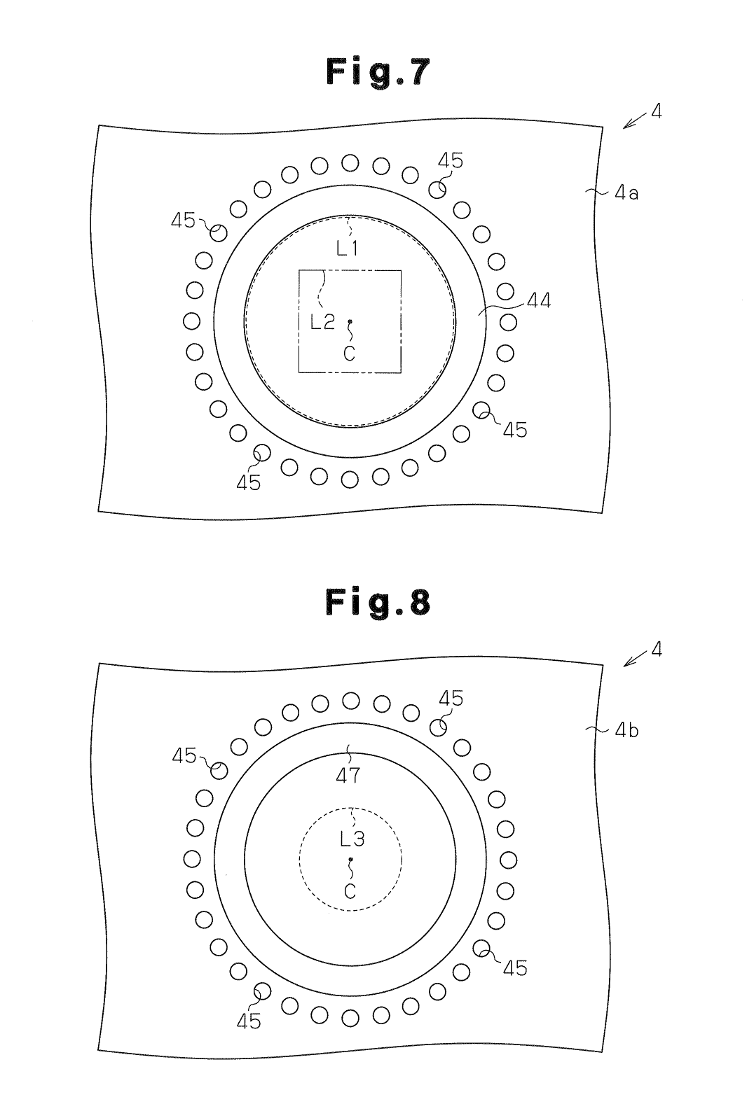

As shown in FIG. 7, a single discharge conductive portion 44, which extends continuously around a switch 72, may be formed on the printed wiring board 4. In this case, the discharge conductive portion 44 may be formed by performing a flow process in which electronic components such as the switch 72 are masked. Further, by eliminating the coating layer and exposing the ground layer 43 from the outmost surface of a printed wiring board, the ground layer 43 may be partially used as the discharge conductive portion 44. Such a structure surrounds the switch 72 with a single discharge conductive portion 44 and provides the discharge conductive portion 44 with a larger area than when the non-continuous discharge conductive portions 44 surround the switch 72.

In the above-described embodiment, the conductor plate 5 contacts the ground connection portion 47 to electrically connect the ground layer 42 to the conductor plate 5. However, the coating layer may be sufficiently eliminated so that the ground layer 42 directly contacts the conductor plate 5.

In the above-described embodiment, a plurality of ground connection portions 47 are arranged so as to surround each switch 72 on the printed wiring board 4. However, as shown in FIG. 8, a single ground connection portion 47, which extends continuously around the switch 72, may be formed on the printed wiring board 4. Such a ground connection portion 47 may be formed by eliminating the coating layer as described above and exposing the ground layer 42 from the outmost surface of the printed wiring board. The ground connection portion 47 may also be formed by performing a flow process. Such a structure provides a larger area of contact between the ground connection portion 47 and the conductor plate 5 than when non-continuous ground connection portions 47 are used and ensures a decrease in the impedance of the contact portion.

In the above-described embodiment, the ground connection portions 47, which are formed, for example, from a solder paste, contacts the conductor plate 5 so as to electrically connect the ground layer 42 to the conductor plate 5. However, a conductive component (not shown) may be used in lieu of the ground connection portions 47 to electrically connect the ground layer 42 and the conductor plate 5.

In the above-described embodiment, to connect the ground layer 42 to the conductor plate 5, the ground layer 42 is simply held in contact with the conductor plate 5, which is connected to the conductor 6 that provides the reference potential of the video projector 1. However, fasteners (not shown), such as screws, washers, and nuts, may be used to connect the ground layer 42 to the conductor plate 5.

In the above-described embodiment, to connect the ground layer 42 to the conductor plate 5, the ground layer 42 is held in contact with the conductor plate 5, which is connected to the conductor 6 that provides the reference potential of the video projector 1. However, the conductor plate 5 may be omitted and the ground layer 42 and the conductor 6 that provides the reference potential may be electrically connected via a conductive wire (not shown). In this case, fasteners (not shown), such as screws, washers, and nuts, may be used to connect the ground layer 42 to the conductive wire.

In the above-described embodiment, conductor plate 5, which contacts the ground layer 42, is discrete from the conductor 6, which provides the reference potential of the video projector 1. However, the conductor plate 5 may be formed integrally with the conductor 6.

In the above-described embodiment, the vias 45 are arranged along a circle. Instead, the vias 45 may be arranged along a polygon. In other words, the layout of the vias 45, which surround each switch 72, may be changed as required in accordance with the slit aperture M formed between the housing 3 and the switch 72.

In the above-described embodiment, as long as each discharge conductive portion 44 may be connected to the ground layer 42 by at least two vias 45, the ground layer 43 may be eliminated.

In the above-described embodiment, the electronic device is not limited to the video projector 1 and may be another type of an electronic device such as a television or audio equipment.

The present examples and embodiments are to be considered as illustrative and not restrictive, and the invention is not to be limited to the details given herein, but may be modified within the scope and equivalence of the appended claims.

What is claimed is:

1. An electronic device comprising:
a housing; and
a printed wiring board accommodated in the housing, with the printed wiring board including:
a substrate;
a ground layer disposed on the substrate;
a discharge conductive portion exposed from an outmost surface of the printed wiring board to provide an antistatic structure; and
a plurality of vias arranged in the substrate, wherein the discharge conductive portion and the ground layer are electrically connected to each other by at least two of the vias.

2. The electronic device according to claim 1, further comprising:
a switch arranged on the printed wiring board;
wherein the plurality of vias are arranged in the printed wiring board so as to surround the switch.

3. The electronic device according to claim 2, wherein:
the printed wiring board includes a further ground layer on which the discharge conductive portion is arranged;
the discharge conductive portion, the further ground layer, and the switch are arranged on a same side of the printed wiring board; and
the discharge conductive portion and the further ground layer are spaced from the switch by a predetermined distance.

4. The electronic device according to claim 2, further comprising:
a push button configured to push the switch;
wherein the discharge conductive portion is aligned with and faces toward a slit aperture formed between the housing and the push button.

5. The electronic device according to claim 2, wherein:
the discharge conductive portion is one of a plurality of discharge conductive portions surrounding the switch; and
the plurality of vias includes vias each sandwiched between two adjacent ones of the discharge conductive portions.

6. The electronic device according to claim 5, wherein each of the discharge conductive portions have a substantially rectangular shape when shown in plan view.

7. The electronic device according to claim 2, wherein the discharge conductive portion extends continuously around the switch.

8. The electronic device according to claim 1, further comprising:
a grounded conductor plate accommodated in the housing; and
a ground connection portion arranged on the ground layer;
wherein the ground connection portion contacts the conductor plate to electrically connect the ground layer and the conductor plate.

9. The electronic device according to claim 1, wherein at least two of the vias connect the discharge conductive portion, which is arranged on a first outmost surface of the printed wiring board, and the ground layer, which is exposed on a second outmost surface of the printed wiring board.

10. The electronic device according to claim 9, wherein:
the discharge conductive portion is one of a plurality of discharge conductive portions arranged on the first outmost surface of the printed wiring board; and
each of the discharge conductive portions is electrically connected to the ground layer by at least two of the plurality of vias.

11. The electronic device according to claim 10, wherein the discharge conductive portion is arranged immediately below a slit aperture formed between the housing and a push button.

12. The electronic device according to claim 11, wherein the plurality of discharge conductive portions are circularly-disposed along a circle on the first outmost surface of the printed wiring board.

13. The electronic device according to claim 12, wherein the plurality of vias are arranged in concentricity with the plurality of discharge conductive portions.

14. The electronic device according to claim 9, wherein the discharge conductive portion is an annular member arranged on the first outmost surface of the printed wiring board.
